(19) United States
(12) Patent Application Publication
(10) Pub. No.: US 2008/0300696 A1
(43) Pub. Date: Dec. 4, 2008

(54) Environment Adaptation for Schizophrenic User

(75) Inventor: Dirk Engelen, Hasselt (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/097,526

(22) PCT Filed: Dec. 11, 2006
(86) PCT No.: PCT/IB06/54744

§ 371 Date: Jun. 14, 2008

(30) Foreign Application Priority Data
Dec. 22, 2005 (EP) 05112739.7

(51) Int. Cl. G05B 11/01

(52) U.S. Cl. 700/19

(57) ABSTRACT

An environmental controller (100) includes a detector (120) configured to detect and select a master (155) from multiple identities (170, 175, 180) of a person in an environment, which may be a real person (165) or virtual person (185). A processor (110) may be configured to control parameters of the environment in accordance with preferences of the master (155) associated with the environment. The parameters may include temperature; personal or business telecommunication; lighting; audio and video sources; security; and/or natural light conditions. The processor (110) may be further configured to control the parameters in accordance with a schedule which includes time, day, and special events occurring in environment, such as an emergency situation, a social or business gathering. The processor (110) may also be configured to effectuate changes in the master (155) such as, in the case where the master has two identities, removing one of the master identities.

The present invention relates to controlling the environment in response to detecting as assumed identity of a person having multiple identities.

Adjustment of parameters of an environment has always been of interest to people. Previously, adjusting an environment usually took the form of a person physically adjusting several systems in the environment individually, for example dimming the lights as desired, modifying the temperature of the environment, disconnecting or reconnecting telecommunication equipment, etc. This method of adjusting an environment is time consuming and seldom do persons adjust the environment to their exact desired specifications every time. Furthermore, the adjusting of an environment could occur several times a day, in the morning, during the workday, returning home, and possibly adjusting to conditions suitable for a social gathering.

Several proposals have been put forth regarding the adjustment of an environment. In one such proposal, set forth in U.S. Pat. No. 6,862,499, which is incorporated herein by reference in its entirety, the space within a transportation unit can be adjusted to meet the parameters of a specific cargo using a controller upon the user identifying the cargo, and the controller retrieving from a memory environmental control parameters as a function of the identified cargo.

Another proposal disclosed in U.S. Patent Application Publication (PAP) No. 2003/0227439, which is incorporated herein by reference in its entirety, provides a system for automatically controlling systems in a local environment where the system process images to identify the current person in the environment from a group of known persons, and generates a control signal as a function of the identified person's preferences for servicing components associated with the local environment where the identified person is present.

A similar system is disclosed in U.S. PAP 2005/0009498, which is incorporated herein by reference in its entirety, where devices are controlled in accordance with prestored user-specific control settings upon authentication of the current user. A further system for controlling an HVAC system is disclosed U.S. PAP 2004/0193548, which is incorporated herein by reference in its entirety, where persons are provided with personal identification numbers (PINs) for use in accessing an interactive user interface of a programmable thermostat. This allows monitoring of air conditioning usage of each user.

Patent Abstract of Japan Publication No. 07-243686, which is incorporated herein by reference in its entirety, also discloses an environmental control system that reads an ID card carried by a person entering a room and accordingly adjusts environmental parameters, such as lights and air conditioning. Although various systems are available for environment control in accordance with prestored preferences, there is a need for improved systems.

Accordingly, an improved environmental controller includes a detector configured to detect and select a master from multiple identities or roles of a person in an environment, which may be a real or virtual person. A processor may be configured to control parameters of the environment in accordance with preferences of the master associated with the environment. Illustratively, the parameters include temperature; telecommunication including personal and/or business telecommunications such as telephone, facsimile, and email whether wired or wireless; lighting; audio and video sources; security; and/or natural light conditions of the environment such as window shades being open or closed.

The processor may be further configured to control the parameters in accordance with a schedule which includes, for example, time, day, and special events occurring in the environment, such as an emergency situation, a social gathering and/or business gathering, where the default gathering may be the social gathering. However, the master or any authorized user may override or inform the system to change any parameters, such as changing the system selected gathering from social to a business gathering. The processor may also be configured to effectuate changes in the master such as, in the case where the master has two identities, for example, removing one of the master identities, e.g., removing Mr. Business or John-The-Employee, upon detection of a social gathering and intercept or direct business calls to an answering machine.

The environmental controller allows a person to be associated with multiple identities, each identity being distinguished from another and being associated with particular environmental parameters according to which the environment is adjusted based on the parameters associated with the selected master and/or associated with the schedule.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

These and other features, aspects, and advantages of the apparatus and methods of the present invention will become better understood from the following description, appended claims, and accompanying drawing where:

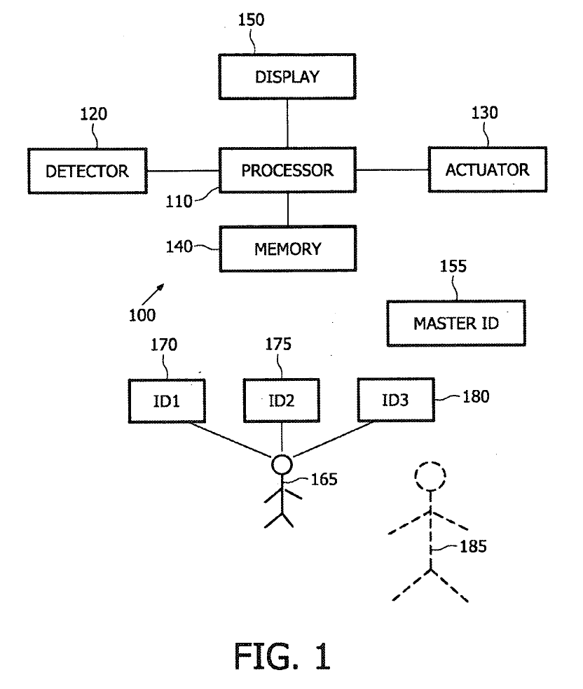

FIG. 1 shows an environmental control system according to one embodiment of the present invention

The following description of certain exemplary embodiment(s) is merely exemplary in nature and is in no way intended to limit the invention, its application, or uses.

Referring to FIG. 1, an environmental control system 100 includes a processor 110 operationally coupled to a detector 120, an actuator 130, a memory 140, and a display 150. The memory 140 may be any type of device for storing application data. The application data is received by the processor 110 for configuring the processor 110 to perform operation acts in accordance with the present system.

The operation acts include controlling the display 150 to display a user interface that depicts visual parameters for selection, programming/re-programming (via the processor 110) and storage in the memory 140, as well as parameters for control of the environment, which may be residential, commercial, retail building, a room, an automobile cabin, and the like. For brevity and simplicity, the environmental control system 100 will be described in the context of a home but it should be understood that the description is equally applicable to any setting or environment where parameters are controllable by the environmental control system 100.

The display 150 may be any display whether stand alone or part of a further system, such as part of a personal computer or laptop, a personal digital assistant (PDA), a monitor, television and the like, including a liquid crystal display (LCD) or a cathode ray tube (CRT) for example. The processor 110 and memory 140 may also be any type of processor/ controller and memory, such as those described in U.S. 2003/0057887, which is incorporated herein by reference. The processor 110 is capable of providing output or control signals in response to input signals from a user interface e.g., displayed on the display 150 which may be a touch sensitive screen, executing instruction stored in the memory 140, which in turn may be any type of memory, RAM, ROM, removable memory, CD-ROM, and the like, also as described in U.S. 2003/0057887.

It should be understood that the user interface device or touch sensitive display 150, the processor 110, memory 140, and actuator 130 although shown as part of the environmental control system 100, may be separate units alone or in combination with other units. For example, the processor 110 and memory 140 may be part of a personal computer, and the user interface device or display 150 may be a separate or integrated unit therewith. The user interface device itself may be implemented in a personal computer or any device capable of accepting user input, storing data and providing control signals, such as remote controllers, PDAs, cell phones and the like.

The actuator 130 is configured to actuate various devices and systems to change various modifiable parameters, such as environmental parameters as will be discussed, which include temperature; telecommunication accessibility including personal and/or business telecommunications such as telephone, facsimile, and email whether wired or wireless; lighting; audio and video sources such as to provide musical preferences; security parameters of security systems; natural light exposure such as via controlling window shades of the environment/room, lighting intensity, lighting colors, and the like.

The detector 120, alone or in combination with processor 110, may be configured to detect and select a master identity 155 from multiple identities of a person 165 in an environment, where three such identities 170, 175, 180 are shown in FIG. 1, but it should be understood that any number of identities may be included.

Such user detection may be by any suitable device, such as ID cards or RFID carried by the users, as disclosed in Patent Abstract of Japan Publication No. 07-243686, image analysis as disclosed in U.S. PAP No. 2003/0227439, for example. As will be described the person 165 may be a real or virtual person. The selection of the master identity may be in accordance with a schedule or may simply be selected by the user/person 165 including overriding any identity selected by the detector 120 and/or processor 110.

The processor 110 is configured to control at least one parameter of the environment in accordance with preferences of the selected master 155 associated with the environment, where such preferences and other preferences associated with each of the multiple identities 170, 175, 180 are stored in the memory 140. Environmental control based on preferences may be similar to controlling lights and temperature as disclosed in U.S. PAP No. 2003/0227439, for example. Illustratively, the parameters include temperature; telecommunication including personal and/or business telecommunications such as telephone, facsimile, and email whether wired or wireless; lighting; audio and video sources; security; and/or natural light conditions such as window shades of the environment.

As noted, the processor 110 may be further configured to control the parameters in accordance with a schedule which includes, for example, time, day, and special events occurring in the environment e.g., in the home or room(s) therein. Special events may be an emergency situation where fire extinguishing sprinklers may be turned on and the fire department called in case of a fire under the control of the processor 110. Additionally, special events may also be a social gathering and/or business gathering, where the default gathering may be the social gathering, for example. However, the master 155 and/or even the person 165, including other persons with authorization, may override or inform the system to change any parameters and selected identities or master(s), such as changing the system selected/identified gathering from a social gathering to a business gathering. The processor 110 may also be configured to effectuate changes in the master such as, in the case where the master has two identities, removing one of the master identities, e.g., removing Mr. Business or John-The-Employee upon detection of a social gathering and intercept or direct business calls to an answering machine.

Of course, each identity and associated preferences are distinguishable by the processor 110 and stored with unique identifiers in the memory 140. The environmental controller 100 allows any person(s) 165 to be associated with multiple identities, each identity being distinguished from another, and being associated with particular environmental parameters according to which the environment is adjusted based on the parameters associated with the selected master and/or associated with the schedule.

An identity may be created through the control system by specifying parameters to be exhibited by the environment. The identity may then be associated with one or multiple persons, real or virtual, through a unique identifier and stored in the memory 140, access to which may be restricted or be allowed after authentication such as through, for example, a signature wave, RIFD, a personal identification number (pin), or a password. The various identities may be selected by the processor 110 based on detected events or identified people in the environment, or associated with a calendar or schedule, for example, a time schedule, a day schedule, or a special event schedule.

Illustratively, upon the person 165 entering a room or any environment, the person 165 is detected by the detector 120 and one of the identities 170, 175, 180 of the person 165 is selected by the detector 120 and/or processor 110. The parameters of the environment are then adjusted to the dictates and/or stored preferences of the selected identity or master 155. If the person 165 leaves the environment, the processor 110 may then adjust the parameters to the previous condition or any other programmed condition. Alternatively, the processor 10 may adjust the parameters to the identity of a virtual person 185.

Following are examples illustrating the environmental control system 100 in use.

### EXAMPLE 1

A person John has created identities A, B, and C, to be associated with himself. Identity A is related to work, e.g., John-The-Employee, wherein the parameters for the environment include bright light, natural light allowed to enter into the room, e.g., blinds open, room temperature at 70° F., no audio noise, and all telecommunications in the “receive/transmit” position. Identity A is time scheduled between 9 am-5 pm Eastern Standard Time (EST), and the day(s) scheduled Monday to Friday.

Identity B is related to happy hour, wherein the parameters for the environment include dim light, no natural light allowed to enter the room, e.g., blinds closed, room temperature at 78° F., audio music set to “jazz”, business telecommunications set to “off”, fax telecommunications set to “off”, and personal telecommunications set to “receive/transmit”. Identity B is time scheduled between 5 pm to 7:30 pm EST, and the day(s) scheduled Monday to Friday. Identity C is related to special events, wherein the parameters include medium light, natural light allowed to enter the room, audio music set to “soft jazz”, room temperature at 74° F., business telecommunications set to “off”, fax telecommunications set to “off”, and personal telecommunications set to “receive/transmit”.

Identity C is not set to a schedule, but will occur as desired by John. Alternatively, John may activate or deactivate any identity when desired, regardless of the time or day.

### EXAMPLE 2

In the environment of a home, Mary has created Identities D and E for herself, and Identities F and G for her son, Gary. The parameters for Identity D include medium light, natural light is allowed to fully enter the room, audio set to “local news station”, business communications set to “urgent only”, personal communications set to “receive/transmit”, and fax communications set to “off”. Identity D is day scheduled to Monday to Friday.

Upon Mary leaving the home environment, the control system will activate Identity E associated with the virtual person caretaker. Identity E may include the parameters of low light, natural light allowed to fully enter the room, audio set to “off”, all telecommunications set to “off, and alarm system set to “fully armed”, and lights and other devices such as multimedia device like the TV or radio turned on/off in any desired/programmable sequence to simulate presence in the home. Identity E is day scheduled to Monday to Friday.

Upon Gary returning from school, the control system will detect Gary, and activate identity F. Identity F may include the parameters of medium light, full natural light, audio set to “Children's music” or any other music associated with identity F, business communications set to “off”, personal communications set to “receive/transmit”, fax communications set to “off”, and security alarm system set to “partially armed” such as only arming perimeter sensors, including door and window sensors, and deactivating motion sensors at least in rooms Gary is expected to be present. Identity F shall be day scheduled for Monday to Friday, and time scheduled between 3:00 pm to 3:30 pm, where Gary may unwind and eat a snack for example.

At 3:30 pm, the control system, detecting Gary and the time 3:30 pm, as well as the day being a weekday, i.e., Monday to Friday, will activate identity G. Identity G may include parameters conducive to studying, such as bright light, no natural light, no audio music, personal communications set to “receive/transmit”, and security alarm system set to “partially armed”.

Upon Mary returning to the home environment, the control system shall detect her, and her identity B shall override Gary's identity G, and create the parameters under identity B including bright light, no natural light, audio set to “off”, business communications set to “off”, fax communications set to “off”, personal communications set to “receive/transmit”, and alarm system set to “partially armed”.

Of course, multiple persons can belong to a single identity, where identity H may belong to both Mary and Gary where unique preferences may be associated with identity H set by the person(s) such as Mary and/or Gary. Alternatively, the preferences may be the combined preferences of both Mary and Gary, which may be an average thereof, a weighted average or certain preferences of one person dominating or taking over conflicting preferences of the other person, for example. Similarly, John and Mary can both be associated with an identity I of a caretaker, which may also be shared with the virtual caretaker, for example, by any weighting, averaging or dominating schemes.

Priorities may be assigned as described in U.S. PAP 2003/0227439. Further, conflicting requirements can be resolved in other ways such as assigning weights to the identities, as noted. For example, in the case a desired temperature has to be calculated for a room, the caretaker looks for the identities present in the room, and calculates a weighted average of their desired temperature. It should be noted that the same person can have different preferences, such as when John is John-The-Employee, then the preferred temperature is 70° F., while a different temperature is preferred when John assumes different identities or roles.

In addition, a rule based approach can be taken such as if the virtual caretaker and/or a virtual entertainer is present in the room, then the temperature preference is 74° F., for example. Conflicts may also be resolved by interaction such as asking the caretaker to set the temperature at a certain level. The caretaker, real or virtual, can consider this request and provide appropriate feedback, be it accepting the request or rejecting it with or without an explanation for example. Of course, the virtual caretaker's role/identity and decisions can be over-ridden by real people with or without proper authorization and authentication.

The virtual person may play a single or multiple roles at any one time, e.g., virtual caretaker and/or virtual entertainer. Interactions between the virtual entertainer and other persons include, for example, during a party real persons asking the virtual entertainer to play specific songs, where illustratively the virtual entertainer decides when to play the requested song. Of course, the virtual entertainer can be programmed to obey commands of particular or all real person. The virtual entertainer can mention that certain identities should be kicked out and deactivated when the party is starting, such de-activating identity A, John-The-Employee. Multiple persons (real and/or virtual) may play a single role. Illustratively, identity I, i.e., The-Caretaker for controlling the blinds of the house and the temperature in rooms, for example, may be associated with the virtual caretaker, with John and/or with Mary.

Finally, the above-discussion is intended to be merely illustrative of the present invention and should not be construed as limiting the appended claims to any particular embodiment or group of embodiments. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) each of the disclosed elements may be comprised of hardware portions (e.g., discrete electronic circuitry), software portions (e.g., computer programming), or any combination thereof.

1. An environmental controller (100) comprising:
a detector (120) configured to detect and select a master (155) from a plurality of identities (170, 175, 180) of a person in an environment; and
a processor (110) configured to control parameters of said environment in accordance with preferences of said master (155) associated with said environment.

2. The environmental controller (100) of claim 1, wherein said parameters include at least one of temperature, telecommunication, lighting, audio, video, security, natural light conditions, and a virtual caretaker of said environment.

3. The environmental controller (100) of claim 2, wherein said telecommunication includes at least one of personal communication, business telecommunication, facsimile telecommunication, email communication, telephone communication, wireless communication, and wired communication.

4. The environmental controller (100) of claim 1, wherein said processor (110) is further configured to control said parameters in accordance with a schedule.

5. The environmental controller (100) of claim 4, wherein said schedule includes at least one of time, day, and detection of at least one event occurring in said environment.

6. The environmental controller (100) of claim 5, wherein said event is at least one of an emergency, a social gathering, and business gathering.

7. The environmental controller (100) of claim 1, wherein said master includes at least two identities of said plurality of identities; said processor being further configured to remove one of said at least two identities.

8. The environmental controller (100) of claim 1, wherein said master (155) includes at least one of real user (165) and virtual user (185).

9. A method of controlling an environment comprising the acts of:
detecting and selecting a master (155) from a plurality of identities of a person in an environment; and
controlling parameters of said environment in accordance with preferences of said master (155) associated with said environment.

10. The method of claim 9, wherein said parameters include at least one of temperature, telecommunication, lighting, audio, video, security, natural light conditions, and a virtual caretaker of said environment.

11. The method of claim 10, wherein said telecommunication includes at least one of personal communication, business telecommunication, facsimile telecommunication, email communication, telephone communication, wireless communication, and wired communication.

12. The method of claim 9, wherein said controlling act controls said parameters in accordance with a schedule.

13. The method of claim 12, wherein said schedule includes at least one of time, day, and detection of at least one event occurring in said environment.

14. The method of claim 13, wherein said event is at least one of an emergency, a social gathering, and business gathering.

15. The method of claim 9, wherein said master includes at least two identities of said plurality of identities; said method further comprising the act of removing one of said at least two identities.

16. The method of claim 9, wherein said master (155) includes at least one of real user (165) and virtual user (185).
